(19) United States
(12) Patent Application Publication
(10) Pub. No.: US 2003/0051957 A1
(43) Pub. Date: Mar. 20, 2003

(54) Shock absorber with a floating piston

(76) Inventor: Rene Lemieux, Granby (CA)

Correspondence Address: PILLSBURY WINTHROP, LLP, P.O. BOX 10500, MCLEAN, VA, 22102, US

(21) Appl. No.: 10/242,659

(22) Filed: Sep. 13, 2002

Related U.S. Application Data
(60) Provisional application No. 60/318,906, filed on Sep. 14, 2001.

(51) Int. Cl. F16F 9/34; F16F 9/00

(52) U.S. Cl. 188/322.15; 188/322.22

(57) ABSTRACT

A shock absorber includes a shock rod having a longitudinal axis. A shock body is disposed around a portion of the shock rod, the shock body defining a fluid chamber therein and being slidable along the shock rod longitudinal axis. A piston is disposed on the shock rod in sealing engagement with the shock body, the piston having at least one channel therethrough in communication with the fluid chamber. The piston is moveable longitudinally in relation to the shock rod within a predetermined range.

This application relies for priority on U.S. Provisional Patent Application Serial No. 60/318,906, entitled “SHOCK ABSORBER WITH FLOATING PISTON,” which was filed on Sep. 14, 2001, the entire contents of which are incorporated herein by reference.

### BACKGROUND OF THE INVENTION

1. Field of the Invention

The field of the present invention relates to shock absorbers that include a piston and shock rod assembly that move within a fluid containing shock housing. The piston is configured to move relative to the shock rod on which it is disposed within a predetermined range.

2. Description of the Related Art

Shock absorbers are widely used in the suspension systems of recreational vehicles such as snowmobiles or all terrain vehicle vehicles. Shock absorbers dampen shocks experienced when the recreational vehicle travels over rough terrain. Shock absorbers are typically mounted between a vehicle component that moves in relation to the chassis and the chassis itself. Shock absorbers are often used in combination with a spring assembly which may or may not be integrated with the shock absorber. In a snowmobile, shock absorbers are typically positioned between the chassis and the slide frame around which an endless track rotates to propel the vehicle or between a front portion of the chassis and the skis. The shock absorber(s) allow the components to compress towards the chassis at a controlled rate. In the case of an all terrain vehicle, the shock absorbers are typically positioned between a wheel assembly and the chassis. The shock absorber(s) allow the wheel assembly to compress towards the chassis at a controlled rate.

Shock absorbers typically have a shock body having a cylindrical wall sealed between first and second end caps creating a cavity in which a fluid is contained. The interior of the shock body is separated into two sections by a piston, which moves within the fluid. Shock absorbers typically include a shock rod having a first end attached to the piston, thus forming a shock rod/piston assembly, and a second end attached to the vehicle. Normally the shock rod is attached to the vehicle chassis through a rod eye. The first end cap, which is typically at the bottom of the shock body includes a mounting structure suitable for coupling to a vehicle component that moves in relation to the chassis. In the case of a snowmobile, the end cap is coupled to the slide frame. In the case of an all terrain vehicle, the end cap is coupled to a wheel assembly. The shock rod extends through the second end cap of the shock body which is named the “rod-eye end cap.” The rod-eye end cap is typically disposed at the top of the shock body.

For the piston to move within the shock body, the fluid within the fluid-filled cavity of the shock body must travel through the piston. Therefore, passages are formed through the piston to control the fluid flow between each section of the shock body. The passages are typically aligned with the longitudinal axis of the piston. The openings of some of these passages may be covered with leaf valves while the remainder of the openings may be uncovered to thus serve as by-pass passages. The only restriction in the by-pass passages is the viscosity of the fluid itself and the diameter of the passages.

The shock rod/piston assembly and the shock body (which includes the cylindrical wall and both of the end caps) move in relation to one another upon the application of forces to the shock absorber. The relative movement between the shock rod/piston assembly and the shock body results in the movement of the piston through the fluid, which provides the hydraulic damping for the shock absorber. Therefore, the shock forces that are applied to the vehicle component, to which the shock absorber is coupled, are at least partially absorbed by the shock absorber. Accordingly, the shock forces that are applied to the vehicle chassis are dissipated by the shock absorber.

The movement of the shock rod/piston assembly within the fluid-filled cavity of the shock body occurs in two stages, a compression stage followed by a rebound stage.

As the vehicle runs over rough terrain, shock forces are applied to the vehicle component to which the shock absorber is mounted. These shock forces cause the vehicle component to move from a steady state position to a position where the vehicle component has compressed relative to the chassis. Since the shock absorber is disposed between the vehicle component and chassis, as the components move toward one another, the shock absorber compresses. This is called the compression stage of the shock absorber. As the shock absorber compresses, the shock rod/piston assembly moves inwardly relative to the shock body, within the fluid-filled cavity of the shock body. As a result, the piston moves within the fluid-filled cavity of the shock body toward the first end cap. During this compression stage, the shock absorber slows or dampens the rate at which the vehicle component compresses toward the chassis.

The rebound stage follows the compression stage. The rebound stage results from the resilient expansion of the spring associated with the shock absorber, which pushes the vehicle component away from the vehicle chassis to the original steady state position. The force exerted by the spring is usually quite low by comparison with the compressive force, because, in the rebound stage, the force of the spring only needs to be high enough to overcome the combined weight of the vehicle and the rider. This spring force causes the shock absorber to extend, resulting in the shock rod/piston assembly extending outwardly relative to the shock body. During the rebound stage, the piston moves within the fluid-filled cavity away from the first end cap toward the second or “rod eye” end cap. As was the case during the compression stage, the shock absorber slows or dampens the rate at which the vehicle component moves relative to the chassis during the rebound stage.

As the shock rod/piston assembly moves inwardly within the shock body, i.e., during the compression stroke, the shock rod displaces a volume of fluid within the shock body that is equal to the volume of the shock rod that has extended into the shock body. To accommodate this displacement of fluid, an external or internal gas-filled reservoir is typically used in association with the shock absorber.

Shock waves are applied to shock absorbers when a vehicle travels over rough terrain. Shock waves may be of a high amplitude or a low amplitude. Shock waves may also be of a high frequency or low frequency. Most shock absorbers accommodate high amplitude/low frequency shock waves well. These high amplitude/low frequency shock waves produce large compressive forces on the shock absorber, easily move the piston/shock rod assembly within the fluid filled shock body, and are easily dampened thereby. Shock waves of low amplitude/high frequency are also encountered frequently. These low amplitude/high frequency shock waves are difficult to accommodate with a shock absorber that is stiff enough to accommodate the high amplitude/low frequency shock waves. The reason for this is that a shock absorber designed to absorb high amplitude/low frequency shock waves is too stiff and will not easily compress to accommodate the low amplitude/high frequency shock waves.

In order for the shock absorber to be efficient, the shock wave or bump encountered must be of sufficient size to compress an external spring (if such a spring is used in association with the shock absorber). If a gas chamber is used in association with the shock absorber, the shock force must be of sufficient size to further compress the compressible gas within in the gas chamber for the piston/shock rod assembly to move inwardly relative to the shock body. Additionally, there are forces (e.g., inertia and friction) within the shock absorber that must be overcome for the piston/shock rod assembly to move relative to the shock body so that the shock absorber will dampen the shock waves.

In a typical shock absorber, the piston includes a sealing surface that engages the shock body. As the piston moves relative to the shock body, the sealing surface slides on the interior surface of the shock body, sealing any passageway for the oil, therefor causing friction between the sealing surface of the piston and the shock body. Accordingly, a force is required to overcome this friction for the piston to move relative to the shock body. A force is also required to cause the viscous fluid within the shock absorber to move through pasages within the piston. If valves are used in combination with the piston, the force of the shock must be sufficient to cause the movement of fluid past the valves.

It is likely for a vehicle to encounter shock waves or bumps that would be sufficient to compress an external spring, if used, to compress the gas within the gas chamber, but nonetheless to not generate a sufficient force to compress the shock absorber, because the magnitude of the shock forces does not overcome the friction between the piston and shock body and/or the force required to pass fluid through the piston and past the valves. In these situations, the shock forces are not dampened by the shock absorber, and the shock forces are transmitted directly to the vehicle chassis. In such a case, the shock forces, therefore, are transmitted to the rider. Under certain riding conditions, a significant proportion of the shock forces are of the type that cannot be dampened easily by existing shock absorbers. The cumulative effect of these low amplitude/high frequency shocks results in rider fatigue and discomfort.

A need, therefore, has developed for a shock absorber that not only accommodates high amplitude/low frequency shocks, but also accommodates low amplitude/high frequency shocks. There is, therefore, a corresponding need for a shock absorber that compresses under low amplitude shock forces. The prior art does not address these needs.

### SUMMARY OF THE INVENTION

It is, therefore, an aspect of the present invention to provide a simple, cost-effective, reliable, shock absorber with improved characteristics.

It is still another aspect of the present invention to provide a shock absorber that not only accommodates high amplitude/low frequency shocks, but also accommodates low amplitude/high frequency shocks.

Accordingly, one aspect of the present invention is to provide a shock absorber that allows the shock rod to move relative to the shock body under low amplitude shock forces, and thus provides damping of low amplitude shock forces.

One aspect of the present invention is to provide a shock absorber having a piston that moves within a predetermined range relative to a shock rod on which the piston is disposed.

Another aspect of the present invention is to provide a shock absorber having a piston assembly that includes a piston and at least one valve. The piston assembly is configured to move within a predetermined range relative to a shock rod on which the piston is disposed.

Yet another aspect of the present invention is to provide a shock absorber having at least one spring disposed on the shock rod. The piston is configured to move against a biasing force provided by the spring, as the piston moves relative to the shock rod.

According to yet another aspect of the present invention, a shock absorber is provided that includes a shock rod having a longitudinal axis. A shock body is disposed around a portion of the shock rod, the shock body defining a fluid chamber therein and being slidable along the shock rod longitudinal axis. A piston is disposed on the shock rod in sealing engagement with the shock body, the piston having at least one channel therethrough in communication with the fluid chamber. The piston is moveable longitudinally in relation to the shock rod within a predetermined range.

The foregoing objects are not meant to limit the scope of the present invention. To the contrary, still other objects of the present invention will become apparent from the description that follows.

### BRIEF DESCRIPTION OF THE DRAWINGS

Reference will be made hereinafter to the accompanying drawings, which illustrate embodiments of the present invention discussed herein below, wherein:

FIG. 1 is a cross-sectional side view of a first embodiment of a shock absorber constructed in accordance with the teachings of the present invention;

FIG. 2 is an exploded, cross-sectional side view of a portion of the shock absorber of the first embodiment of the present invention illustrated in FIG. 1;

FIG. 3 is a cross-sectional side view of a portion of a second embodiment of a shock absorber constructed in accordance with the teachings of the present invention;

FIG. 4 is an exploded, cross-sectional side view of a portion of the shock absorber of the second embodiment of the present invention illustrated in FIG. 3;

FIG. 5 is an exploded, cross-sectional side view of a portion of a third embodiment of a shock absorber constructed in accordance with the teachings of the present invention;

FIG. 6 is an exploded, cross-sectional side view of a portion of a fourth embodiment of a shock absorber constructed in accordance with the teachings of the present invention;

FIG. 7 is an exploded, cross-sectional side view of a portion of a fifth embodiment of a shock absorber constructed in accordance with the teachings of the present invention;

FIG. 8 is a cross-sectional side view of a sixth embodiment of a shock absorber constructed in accordance with the teachings of the present invention;

FIG. 9 is an exploded, cross-sectional side view of a portion of the shock absorber of the sixth embodiment of the present invention illustrated in FIG. 8;

FIG. 10 is a cross-sectional side view of a seventh embodiment of a shock absorber constructed in accordance with the teachings of the present invention;

FIG. 11 is an exploded, cross-sectional side view of a portion of the shock absorber of the seventh embodiment of the present invention illustrated in FIG. 10;

FIG. 12 is an exploded, cross-sectional side view of a portion of an eighth embodiment of a shock absorber constructed in accordance with the teachings of the present invention;

FIG. 13 is an exploded, cross-sectional side view of a portion of a ninth embodiment of a shock absorber constructed in accordance with the teachings of the present invention;

FIG. 14 is an exploded, cross-sectional side view of a portion of a tenth embodiment of a shock absorber constructed in accordance with the teachings of the present invention.

FIG. 15 is a cross-sectional side view of a portion of an eleventh embodiment of a shock absorber constructed in accordance with the teachings of the present invention;

FIG. 16 is an exploded, cross-sectional side view of a portion of the shock absorber of the eleventh embodiment of the present invention illustrated in FIG. 15;

FIG. 17 is a cross-sectional side view of a twelfth embodiment of a shock absorber constructed in accordance with the teachings of the present invention;

FIG. 18 is an exploded, cross-sectional side view of a portion of the shock absorber of the twelfth embodiment of the present invention illustrated in FIG. 17;

FIG. 19 is an exploded, cross-sectional side view of a portion of a thirteenth embodiment of a shock absorber constructed in accordance with the teachings of the present invention;

FIG. 20 is an exploded, cross-sectional side view of a portion of a fourteenth embodiment of a shock absorber constructed in accordance with the teachings of the present invention; and

FIG. 21 is an exploded, cross-sectional side view of a portion of a fifteenth embodiment of a shock absorber constructed in accordance with the teachings of the present invention.

### DETAILED DESCRIPTION OF THE INVENTION

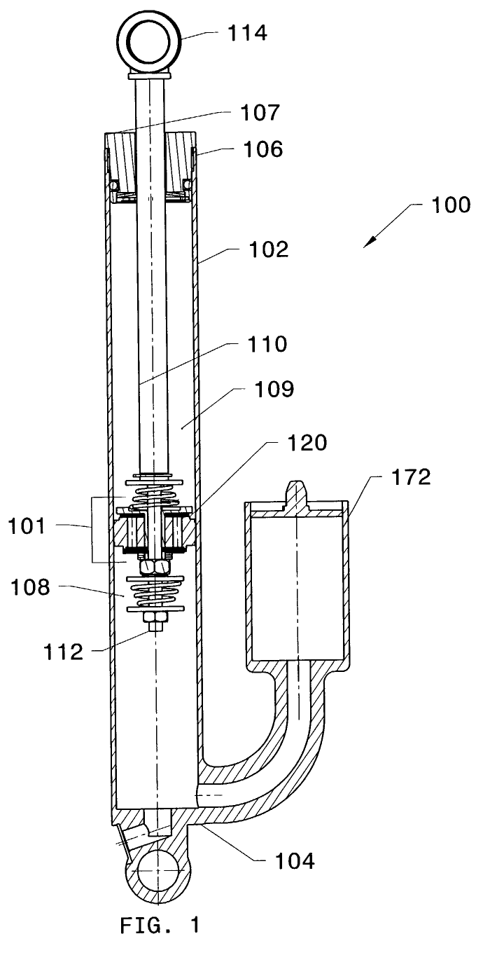

FIG. 1 shows a first embodiment of the shock absorber 100 of the present invention. The shock absorber 100 generally comprises a cylindrically-shaped shock body 102 defining a fluid-filled chamber or cavity 101. The shock body 102 is shown in cross-section. The shock body 102 includes a closed first end 104 and a second end 106. An end cap 107, shown in cross-section, is disposed within the second end 106, to enclose the fluid chamber 101. A shock rod 110 having a longitudinal axis is partially disposed within the shock body 102. The shock rod 110 includes a first end portion 112 that is disposed within the shock body 102, and a second end 114 that is disposed outside of the end cap 107. The shock rod second end 114 includes a rod eye which is typically used to attach the shock absorber 100 to a vehicle chassis. As the end cap 107 is disposed proximate to the rod eye of the shock rod second end 114, the end cap 107 may be referred to as the rod eye end cap. A piston 120 (which in this embodiment is a piston assembly) is disposed on the shock rod 110 proximate to the first end portion 112 of the shock rod 110. The piston assembly 120 is shown in cross-section. The piston assembly 120 separates fluid (not shown) within the shock body fluid chamber 101 into a compression chamber 108 and a rebound chamber 109. The piston assembly 120 is in sealing engagement with the inside surface of the shock body 102.

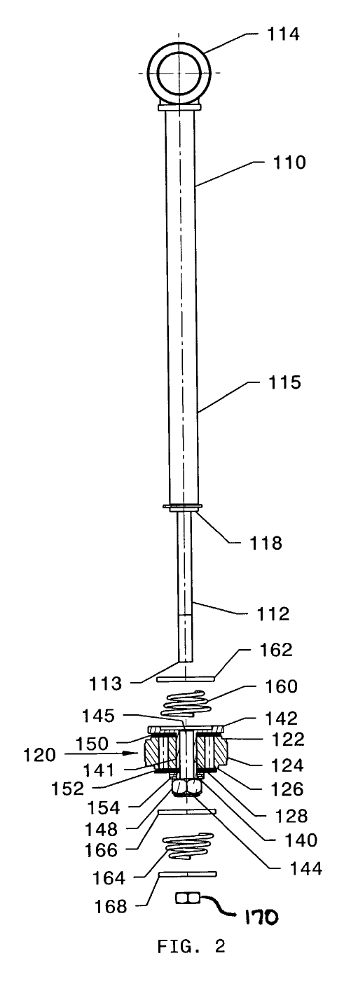

FIG. 2 shows the features of the shock rod 102 and the piston assembly 120 in exploded detail. The shock rod 110 is shown including a large diameter portion 115 and a reduced diameter first end portion 112, which terminates at a distal end 113. A shoulder 118 separates the reduced diameter first end portion 112 from the large diameter portion 115. The large diameter portion 115 extends from shoulder 118 to the second end 114 of the shock rod 110.

The piston assembly 120 includes a piston body 122. A sealing surface 124 defines the perimeter of the piston body 122. The sealing surface 124 is adapted for sealing contact with the inner surface of the shock body 102. A plurality of channels 126 are disposed within the piston body 122. The channels 126 provide fluid communication between the compression chamber 108 and the rebound chamber 109. A large central conduit 128 is disposed through the piston body 122 to accommodate the reduced diameter portion 112 of the shock rod 110.

The piston body 122 is disposed on a piston support 140. The piston support 140 includes a hollow piston support body 141 having a first end 142 and a second end 144. The first end 142 comprises an outwardly extending ring-shaped flange which is integral with the piston support body 141. A conduit 145 extends through the entire piston support 140. The conduit 145 is sized such that the shock rod first end 112 may pass therethrough. The piston body 122 is shown disposed on the outside of the piston support body 141. The piston support second end 144 is adapted to receive a fastener such as a nut 148.

A valve 150 comprising a plurality of circular disks made of flexible material is preferably disposed between the piston support outwardly extending flange 142 and an upper end surface of the piston body 122. The valve 150 has a circular inner opening through which the piston support body 141 extends. The valve 150 is constructed to flex when a predetermined amount of pressure is applied thereto. A second valve 152 is preferably disposed adjacent the bottom surface of the piston body 122. The valves 150 and 152 are typically referred to as “leaf valves.” A series of spacer washers 154 are disposed between the nut 148 and the second valve 152. The nut 148 serves to retain the first valve 150, piston body 122, second valve 152, and spacer washers 154 on the piston support 140.

A first coil spring 160 and an associated washer 162 are disposed on the shock rod between the shoulder 118 and the outwardly extending flange 142 of the piston support 140. The first coil spring 160 and the washer 162 each include a passage through which the shock rod first end portion 112 extends. A second coil spring 164 and an associated washers 166, 168 are disposed on the shock rod 110 between the nut 148 and a nut 170, which is fastened to the distal end 113 of the shock rod 110. The second coil spring 164 and the washers 166, 168 each include a passage through which the shock rod first end portion 112 extends. The shoulder 118 and the washer 162 function as a spring support surface for the first coil spring 160. The nut 170 and the washers 166, 168 function as a spring support surface for the second coil spring 164. Obviously, the shoulder 118 and the nut 170 could be constructed of a sufficient diameter to eliminate the necessity of the washers 162 and 168.

The piston assembly 120 is moveable longitudinally in relation to the shock rod 110 within a predetermined range. Specifically, the shock rod first end portion 112 is slidable within the conduit 145, which extends through the piston support 140. The piston assembly 120 is biased by the first and second coil springs 160 and 164 to an initial position between the shoulder 118 and the nut 170. The piston assembly 120 is moveable longitudinally on the shock rod first end portion 112 generally between the shoulder 118 and the nut 170.

In use, during the compression of stage of the shock absorber 100, the piston assembly 120 and the shock rod 110 move (downwardly in FIG. 1) relative to the shock body 102 toward the shock body first end 104. As the piston assembly 120 is in sealing engagement with the inside surface of the shock body 102, the fluid within the shock 100 must pass through the piston body channels 126 for the piston assembly 120 to move within the shock body 102. All of the individual flexible disks that comprise the valve 150 must flex to allow the fluid to pass through the channels 126. Accordingly, to move the piston assembly 120 downwardly during this compression stage, a sufficient compression force must be applied to the shock absorber 100 for the fluid in the compression chamber 108 to exert a sufficient force on the valve 150 to flex the valve sufficiently to allow the passage of fluid through the channels 126. The piston assembly 120 also encounters resistance from the fluid within the shock body compression chamber 108. This fluid resistance must also be overcome for the piston assembly 120 to move relative to the shock body 102. And, as there is a degree of friction between the piston body sealing surface 124 and the shock body 102, the compression force applied to the shock absorber 100 must also overcome the friction between piston body sealing surface 124 and the inner surface of the shock body 102 for the piston assembly 120 to move relative to the shock body 102.

Even if a compression force applied to the shock absorber 100 is insufficient to overcome the cumulative forces of the valve 150, the fluid resistance, and the friction between the piston sealing surface 124 and the shock body 102 to move the piston assembly 120, the shock rod 110 may still be able to move relative to the shock body 102 under this smaller compression force. As the piston assembly 120 is moveable relative to the shock rod 110, a small compression force acting on the shock absorber 100 needs only to overcome the small spring force of the first coil spring 160 for the shock rod 110 to move relative to the shock body 102. Stated differently, the spring force of the first coil spring 160 defines the force which must be overcome for the shock rod 110 to move relative to the shock body 102.

Upon the application of a small compressive force to the shock absorber 100, the shock rod 110 will move downwardly toward the piston assembly 120. Again, this is the compression stage of the shock absorber 100. The first coil spring 160 will compress under the compression force. The first coil spring 160 is accordingly compressed between the outwardly extending flange 142 of the piston support 140 and the spring support surface provided by the shoulder 118 and the washer 162. If the force is great enough, the shock rod 110 will fully compress the first coil spring 160 and release the pressure on spring 164. Once the first coil spring 160 is fully compressed, the shock rod 110 will push downwardly on the piston assembly 120 resulting in the piston assembly 120 moving downwardly within the shock body 102.

A rebound stage follows the aforementioned compression stage of the shock absorber 100. During the rebound stage, an external coil spring (not shown) associated with the shock absorber 100 will resiliently expand. The resiliently expanding spring exerts a force on the shock absorber 100 causing the shock absorber 100 to extend and return to a initial position. During the rebound stage, the second coil spring 164 acting on the piston assembly 120 will bias the piston assembly 120 back to the initial position between the shoulder 118 and the nut 170. The second coil spring 164 equalizes the force on the piston assembly 120 ensuring that the piston assembly 120 will return to the initial position during periods between the application of compression forces. Also during the rebound stage, the fluid within the shock absorber 100 must again pass through the piston body channels 126 for the piston assembly 120 to move within the shock body 102. All of the individual flexible disks that comprise the valve 152 must flex to allow the fluid to pass through the channels 126.

Upon a small rebound force, the shock rod 110 will move upwardly toward the piston assembly 120. The coil spring 164 will compress under the rebound force and the coil spring 164 is accordingly compressed between washers 166 and 168.

If the bumps encountered are not large enough to create a force to overcome the friction forces between the piston assembly and the shock body and the pressure within the gas chamber 172, the shock body 102 and the piston assembly 120 will move as one unit with respect to the shock rod 110. In this case, springs 160 and 164 will absorb the energy of the forces created by the bumps before they reach the chassis of the vehicle.

If the force is great enough to completely compress the springs 160 or 164, overcome the friction between the piston assembly 120 and the shock body 102, and overcome the pressure within the gas chamber 172, then the relative movement of piston assembly 120 within the shock body 102 will absorb the remaining energy not absorbed by the springs 160 or 164.

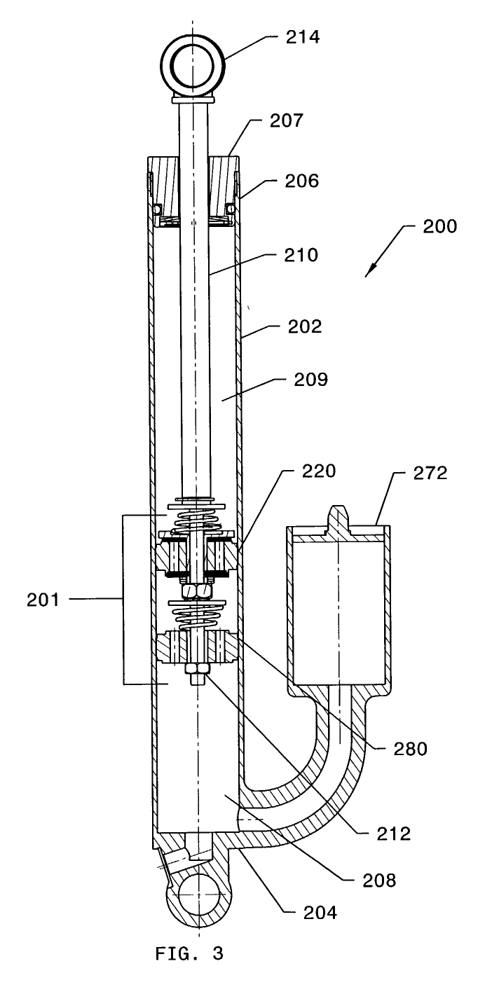

FIG. 3 shows a second embodiment of the shock absorber 200 of the present invention. The shock absorber 200 generally comprises a cylindrical shaped shock body 202 defining a fluid-filled chamber or cavity 201. The shock body 202 is shown in cross-section. The shock body 202 includes a closed first end 204 and a second end 206. An end cap 207, shown in cross-section, is disposed within the second end 206, to enclose the fluid chamber 201. A shock rod 210 having a longitudinal axis is partially disposed within the shock body 202. The shock rod 210 includes a first end portion 212 that is disposed within the shock body 202, and a second end 214 that is disposed outside of the end cap 207. The shock rod second end 214 includes a rod eye which is typically used to attach the shock absorber to a vehicle chassis. As the end cap 207 is disposed proximate to the rod eye of the shock rod second end 214, the end cap 207 may be referred to as the rod eye end cap. A piston 220 (which in this embodiment is a piston assembly) is disposed on the shock rod 210 proximate to the first end portion 212 of the shock rod 210. The piston assembly 220 is shown in cross-section. The piston assembly 220 separates fluid (not shown) within the shock body fluid chamber 201 into a compression chamber 208 and a rebound chamber 209. The piston assembly 220 is in sealing engagement with the inside surface of the shock body 202. A guide 280 is disposed on the shock rod 210 proximate to the first end portion 212 of the shock rod 210. The guide 280 is in engagement with the inside surface of the shock body 202. The guide 280 may be in sealing engagement, if desired, but a sealing engagement is not required to practice the present invention.

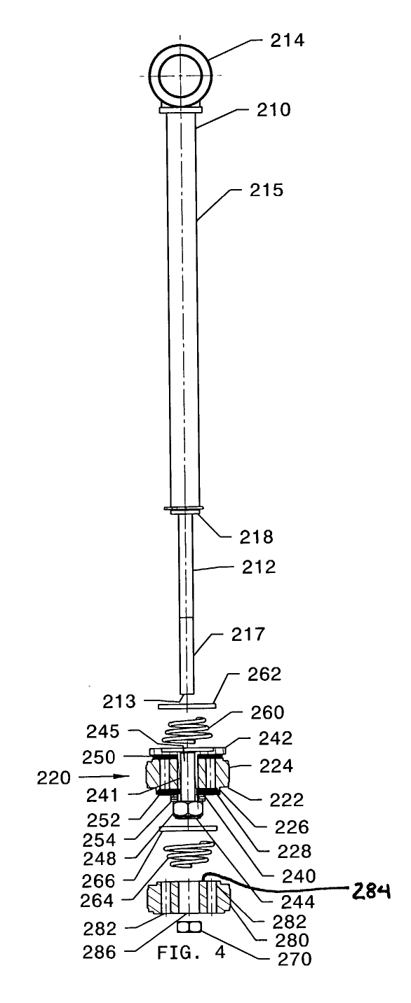

FIG. 4 shows the features of the shock rod 210 and the piston assembly 220 in greater detail in an exploded view. The shock rod 210 is shown including a large diameter portion 215, and a reduced diameter first end portion 212 which terminates at a distal end 213. A shoulder 218 separates the reduced diameter first end portion 212 from the large diameter portion 215. The large diameter portion 215 extends from shoulder 218 to the second end 214 of the shock rod 210.

The piston assembly 220 includes a piston body 222. A sealing surface 224 forms the periphery of the piston body 222. A plurality of channels 226 are disposed within the piston body 222. The channels 226 provide fluid communication between the compression chamber 208 and the rebound chamber 209. A large central conduit 228 is disposed through the piston body 222 to accommodate the reduced diameter first end portion 212 there through.

The piston body 222 is disposed on a piston support 240. The piston support 240 includes a hollow body 241 having a first end 242 and a second end 244. The first end 242, comprises an outwardly extending ring-shaped flange which is integral with the piston support body 222. A conduit 245 extends through the entire piston support 240. The conduit 245 is sized such that the shock rod first end portion 212 may pass therethrough. The piston body 222 is shown disposed on the outside of the piston support body 241. The piston support second end 244 is adapted to receive a fastener such as a nut 248.

A valve 250 comprising a plurality of circular disks made of flexible material is preferably disposed between piston support outwardly extending flange 242 and an upper end surface of the piston body 222. The valve 250 has a circular inner opening through which the piston support body 241 extends. The valve 250 is constructed to flex when pressure is applied thereto. A second valve 252 is preferably disposed adjacent the bottom surface of the piston body 222. A series of spacer washers 254 are disposed between the nut 248 and the second valve 252. The nut 248 serves to retain the first valve 250, piston body 222, second valve 252, and spacer washers 254 on the piston support 240.

A first coil spring 260 and an associated washer 262 are disposed on the shock rod between the shoulder 218 and the outwardly extending flange 242 of the piston support 240. The first coil spring 260 and the washer 262 each include a passage through which the shock rod first end portion 212 extends. A second coil spring 264 is disposed on the shock rod between the nut 248, washer 266 and the guide 280. The second coil spring 264 includes a passage 286 through which the shock rod first end portion 212 extends. The shoulder 218 and the washer 262 function as a spring support surface for the first coil spring 260. An upper surface 284 of the guide 280 functions as a spring support surface for the second coil spring 264. Obviously, the shoulder 218 could be constructed of a sufficient diameter to eliminate the necessity of the washer 262.

The piston assembly 220 is moveable longitudinally in relation to the shock rod 210 within a predetermined range. Specifically, the shock rod first end portion 212 is slidable within the conduit 245, which extends through the piston support 240. The piston assembly 220 is biased by the first and second coil springs 260 and 264 to an initial position between the shoulder 218 and the nut 270 or the guide 280. The piston assembly 220 is moveable longitudinally on the shock rod first end portion 212 generally between the shoulder 218 and the guide 280.

In use, during the compression stage of the shock absorber 200, the piston assembly 220 and the shock rod 210 move downwardly in FIG. 3, relative to the shock body 202 toward the shock body first end 204. As the piston assembly 220 is in sealing engagement with the inside surface of the shock body 202, the fluid within the shock absorber 200 must pass through the piston body channels 226 for the piston assembly 220 to move within the shock body 202. All of the individual flexible disks that comprise the valve 250 must flex to allow the fluid to pass through the channels 226. Accordingly, to move the piston assembly 220 downwardly during this compression stage, a sufficient compression force must be applied to the shock absorber 200 for the fluid in the compression chamber 208 to exert a sufficient force on the valve 250 to flex the valve sufficiently to allow the passage of fluid through the channels 226. The piston assembly 220 also encounters resistance from the fluid within the shock body compression chamber 208. This fluid resistance must also be overcome for the piston assembly 220 to move relative to the shock body 202. And, as there is a degree of friction between the piston body sealing surface 224 and the shock body 202, the compression force applied to the shock absorber 200 must also overcome the friction between piston body sealing surface 224 and the inner surface of the shock body 202 for the piston assembly 220 to move relative to the shock body 202. Since the guide 280, which at least partially sealingly engages the inner surface of the shock body 202, includes a plurality of passages therethrough, the guide 280 offers little resistance to the movement of the shock rod 210.

Even if a compression force applied to the shock absorber 200 is insufficient to overcome the cumulative forces of the valve 250, the fluid resistance, and the friction between the piston sealing surface 224 and the shock body 202 to move the piston assembly 220, the shock rod 210 may still be able to move relative to the shock body 202 under this smaller compression force. As the piston assembly 220 is moveable relative to the shock rod 210, a small compression force acting on the shock absorber 200 needs only to overcome the small spring force of the first coil spring 260 for the shock rod 210 to move relative to the shock body 202. Stated differently, the spring force of the first coil spring 260 defines the force which must be overcome for the shock rod 210 to move relative to the shock body 202.

Upon the application of a small compressive force to the shock absorber 200, the shock rod 210 will move downwardly toward the piston assembly 220. Again, this is the compression stage of the shock absorber 200. The first coil spring 260 will compress under the compression force. The first coil spring 260 is accordingly compressed between the outwardly extending flange 242 of the piston support 240 and the spring support surface provided by the shoulder 218 and the washer 262. If the force is great enough, the shock rod 210 will fully compress the first coil spring 260 and release the pressure on coil spring 264. Once the first coil spring 260 is fully compressed, the shock rod 210 will push downwardly on the piston assembly 220 resulting in the piston assembly 220 moving downwardly within the shock body 202.

A rebound stage follows the aforementioned compression stage of the shock absorber. During the rebound stage, a spring (not shown) associated with the shock absorber 200 will resiliently expand. The resiliently expanding spring exerts a force on the shock absorber 200 causing the shock absorber 200 to extend and return to a initial position. During the rebound stage, the second coil spring 264 acting on the piston assembly 220 will bias the piston assembly 220 back to the initial position between the shoulder 218 and the nut 270. The second coil spring 264 equalizes the force on the piston assembly 220 ensuring that the piston assembly 220 will return to the initial position during periods between the application of compression forces. Also during the rebound stage, the fluid within the shock absorber 200 must again pass through the piston body channels 226 for the piston assembly 220 to move within the shock body 202. All of the individual flexible disks that comprise the valve 252 must flex to allow the fluid to pass through the channels 226.

Also, during the use of the shock absorber 200, the guide 280 will move in association with the shock rod 210 and will prevent undesirable radial movement of the shock rod 210 with respect to the shock body 202. Specifically, as the shock rod 210 is capable of movement relative to the piston assembly 220, there is a greater chance that the shock rod 210 or piston assembly 220 will deflect or become displaced slightly with respect to the longitudinal axis of the shock body 202 (a longitudinal deflection). Should this displacement occur, the shock rod 210 will not move properly within the shock body 202 and may bind. The guide 280 restricts the radial displacement of the shock rod 210 which can occur, and ensures that the shock absorber 200 will work as intended. It is understood that the shock guide 280 may not be necessary in all situations but is preferred in situations where the forces applied to the shock absorber 200 may cause a deflection or displacement of the shock rod 210 with respect to the shock body longitudinal axis.

Upon a small rebound force, the shock rod 210 will move upwardly with respect to the piston assembly 220. The coil spring 264 will compress under the rebound force and the coil spring 264 is accordingly compressed between the washer 266 and the guide 280.

If the bumps encountered are not large enough to create a force to overcome the friction forces between the piston assembly 220, the shock body 202, and the pressure within the gas chamber 272, the shock body 202 and the piston assembly 220 will move as one unit with respect to the shock rod 210. In this case, springs 260 and 264 will absorb the energy of the forces created by the bumps before they reach the chassis of the vehicle.

If the force is great enough to completely compress the springs 260 or 264, overcome the friction between the piston assembly 220 and the shock body 202, and overcome the pressure within the gas chamber 272, then the relative movement of piston assembly 220 within the shock body 202 will absorb the remaining energy not absorbed by the springs 260 or 264.

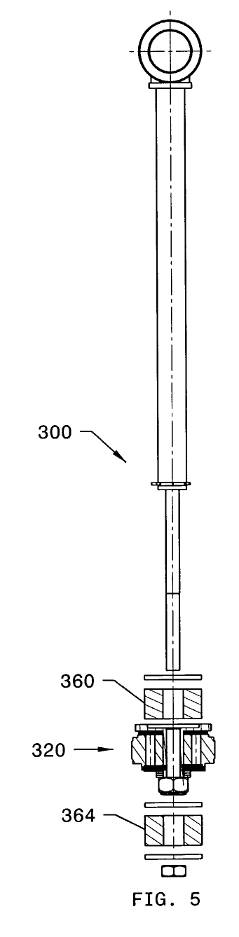

FIGS. 5, 6, and 7 illustrate variations of the embodiment of the invention shown in FIGS. 1 and 2. Each show further embodiments of the present invention having compression springs, other than coil springs, which bias the piston assembly. Each of these embodiments operates in the same manner as the embodiments shown in FIGS. 1 and 2, with obvious variations due to the different springs employed.

FIG. 5 shows a shock rod assembly 300 with first and second rubber or elastomeric springs 360 and 364 on opposite sides of the piston assembly 320.

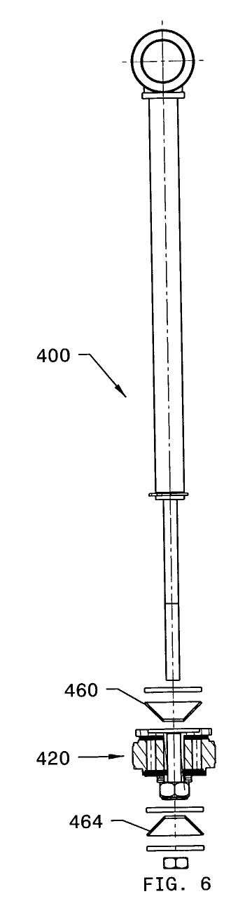

FIG. 6 shows a shock rod assembly 400 with first and second cup springs 460 and 464 on opposite sides of the piston assembly 420. The cup springs are also known as Belleville washers.

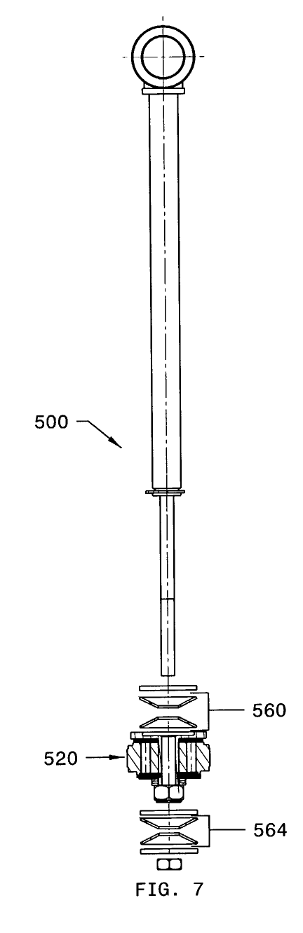

FIG. 7 shows a shock rod assembly 500 with first and second paired cup springs 560 and 564 on opposite sides of the piston assembly 520.

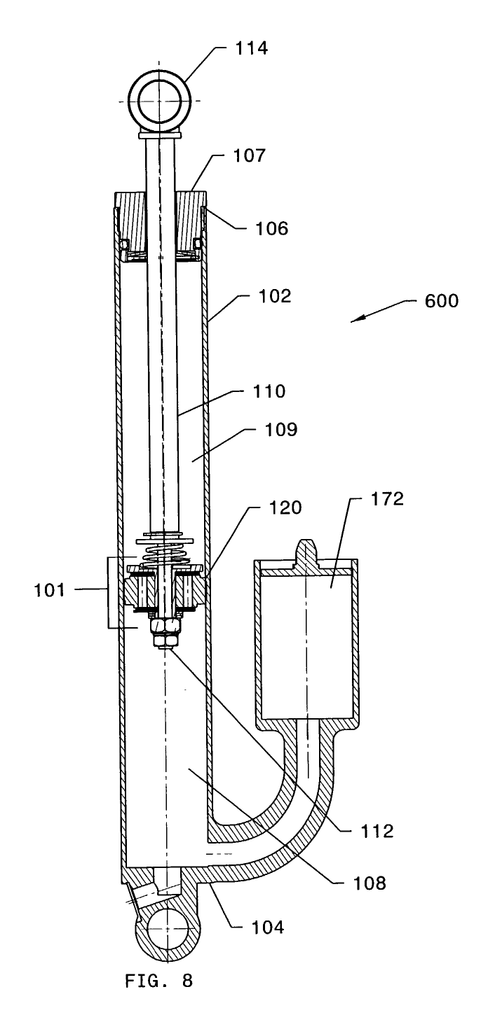

FIG. 8 illustrates shock absorber 600, which is contemplated as yet another embodiment of the invention. As the shock rod/piston assembly moves inwardly within the shock body 102, the shock rod 110 displaces a volume of fluid within the shock body 102 that is equal to the volume of the shock rod 110 that has extended into the shock body 102. To accommodate this displacement of fluid, a reservoir such as a gas chamber 172 is operatively connected to the shock absorber 600. As known by one skilled in the art, other methods, such as twin-tube type shock absorbers, can achieve the desired results without deviating from the scope of that invention.

FIG. 8 is similar in construction to the embodiment shown in FIG. 1 with exception to that second spring 164 has been removed. While it is believed that the removal of the second spring 164 possibly will have an impact on overall operation of the shock absorber 600 by comparison with the shock absorber 100, for example, the shock absorber 600 is believed to offer the same advantages as the shock absorber 100.

In certain applications, such as with a very lightweight vehicle, the amount of shock absorption in the rebound stage is relatively unimportant compared to the amount of shock absorption needed in the compression stage. Therefor, in order to reduce the amount of weight and cost of the overall shock absorber, spring 164, as shown in FIG. 1, has been removed from shock absorber 600. The shock absorber 600 functions in the same manner as the shock absorber 100 described above when encountering forces in the compression stage. The shock absorber 600 also functions as a conventional shock absorber in the rebound stage where, if the rebound forces are not high enough to overcome the friction between the piston assembly 120 and the shock body 102 and the gas pressure within reservoir 172, the rebound forces will be transmitted directly to the chassis of the vehicle.

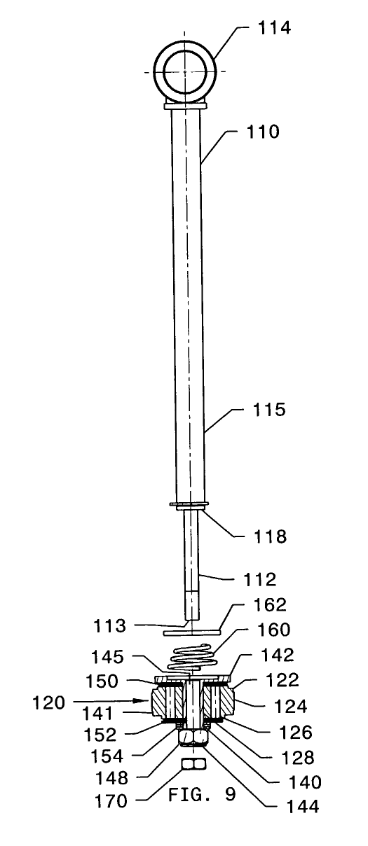

FIG. 9 illustrates the shock rod assembly from the shock absorber 600 illustrated in FIG. 8. The shock rod assembly is shown in exploded detail for a clear understanding of the embodiment.

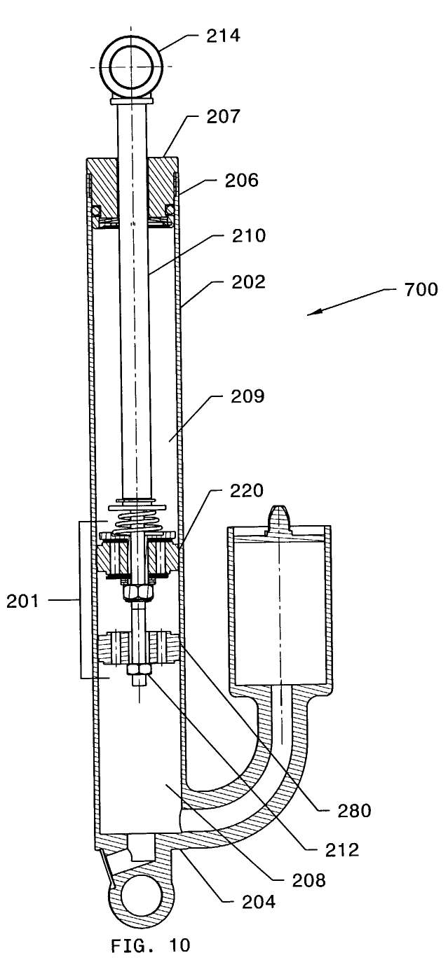

FIG. 10 illustrates yet another embodiment of the invention. The shock absorber 700 is a variation of the shock absorber 200 illustrated in FIG. 2. In this embodiment, the second spring 264 has been removed just as with the embodiment illustrated in FIG. 8 and 9. As shown, the shock absorber 700 includes a guide 280 disposed at the end of the shock rod 210 within the shock body 202. The shock absorber 700 operates in the same manner as the shock absorber 200, described above.

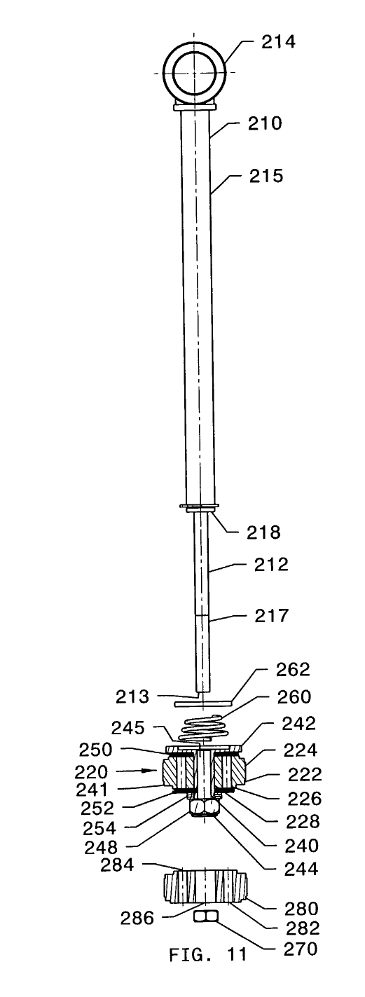

FIG. 11 illustrates the shock rod assembly from the shock absorber 700 shown in FIG. 10. The shock rod assembly is illustrated in exploded detail for a better understanding of this embodiment of the invention.

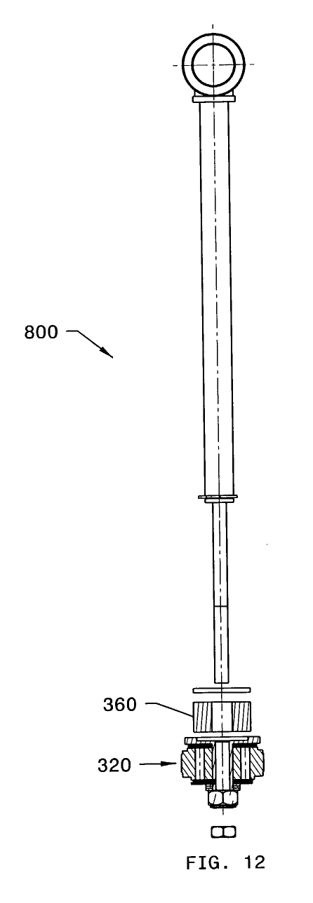

FIGS. 12, 13, and 14 illustrate variations of the embodiment of the shock rod assembly illustrated in FIGS. 10 and 11. In these variations, the compression spring 260 has been replaced by other spring types. These embodiments of the invention operate in the same manner as described above.

FIG. 12 illustrates a shock rod assembly 800 with a rubber spring 360 disposed adjacent to the piston assembly 320 on the side closest to the top of the shock rod 110.

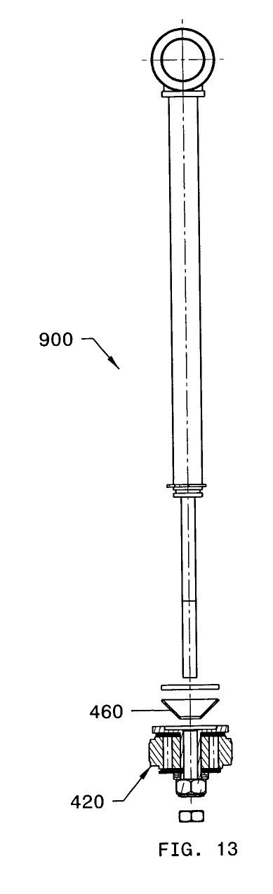

FIG. 13 illustrates a shock assembly 900 where the compression spring has been replaced by a cup spring 460. As illustrated, the cup spring 460 is disposed adjacent to the piston assembly on the side closest to the top of the shock rod 110.

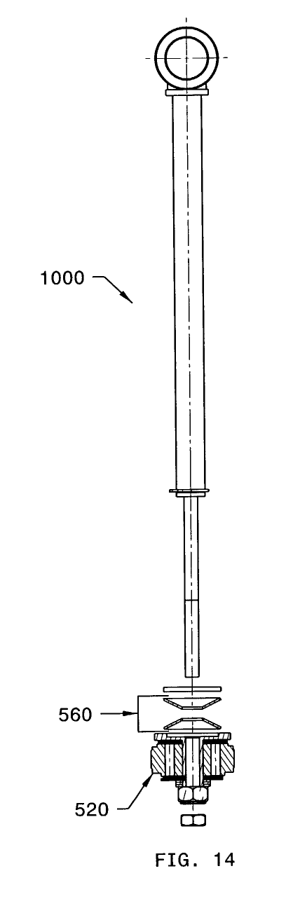

FIG. 14 illustrates the construction of a shock rod assembly 1000. Here, the compression spring has been replaced by two cup springs 560 disposed side-by-side. The cup springs 560 are disposed adjacent to the piston assembly 520 on the side closest to the top of the shock rod.

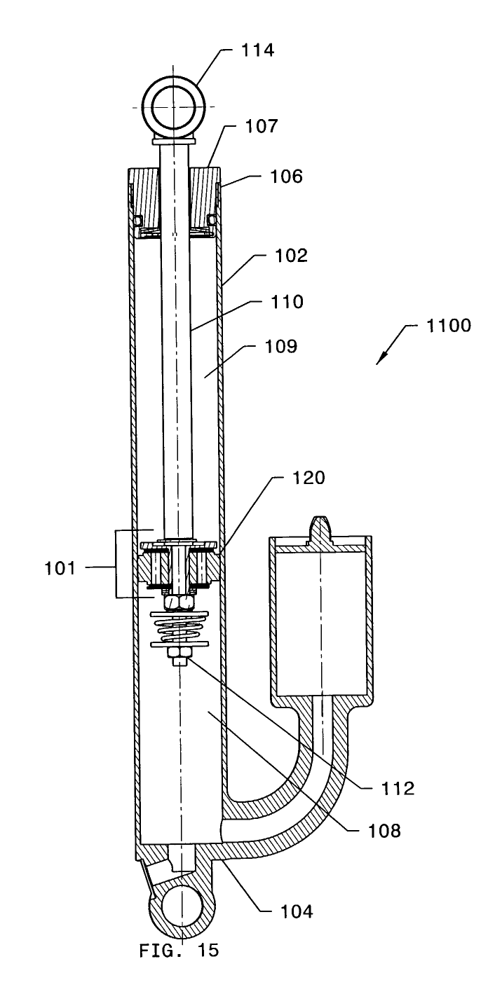

FIG. 15 illustrates a shock absorber 1100 that is yet another variation of the shock absorber 100 shown in FIGS. 1 and 2. Here, the second compression spring 164 has been retained and the first compression spring 160 has been removed. This embodiment of the invention operates in the same manner as described above.

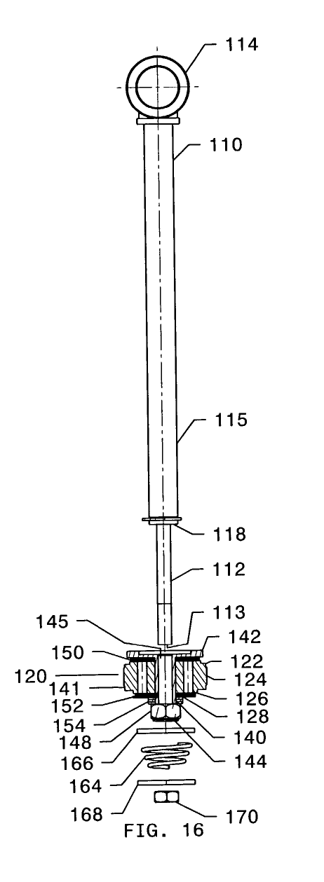

FIG. 16 provides an exploded detail of the shock rod assembly for the shock absorber 1100.

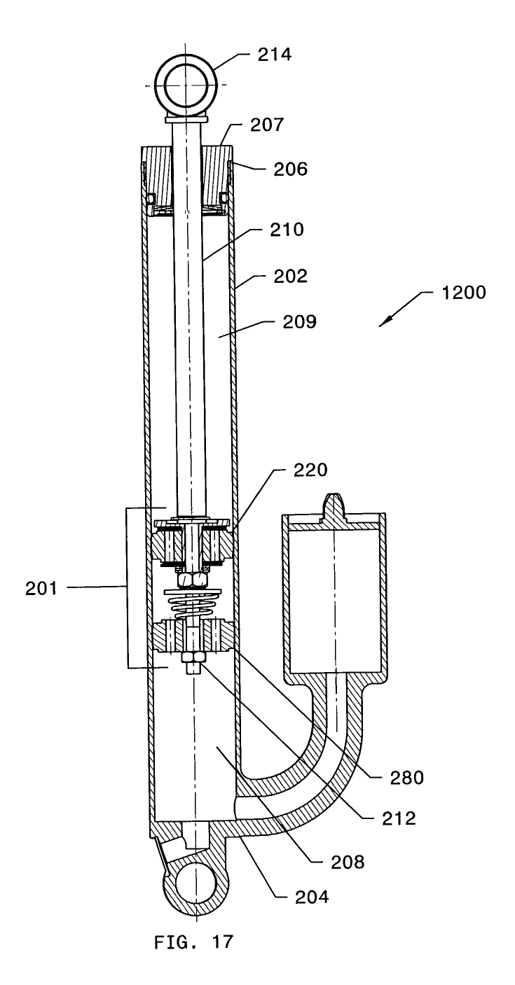

FIG. 17 illustrates a shock absorber 1200. This embodiment is a variation of the shock absorber 200 shown in FIGS. 3 and 4. As with the embodiment of the shock absorber shown in FIGS. 15 and 16, the first compression spring 160 has been removed, leaving only the second compression spring 164. This embodiment also operates in the same manner as the other embodiments described above.

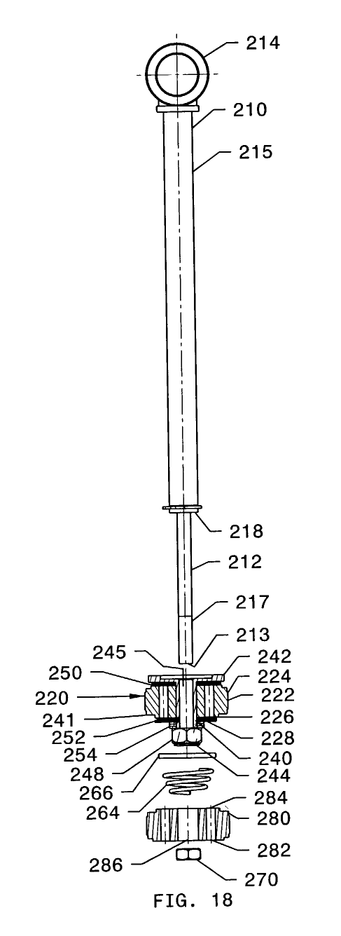

FIG. 18 illustrates the construction of the shock rod assembly for the shock absorber 1200 in exploded detail.

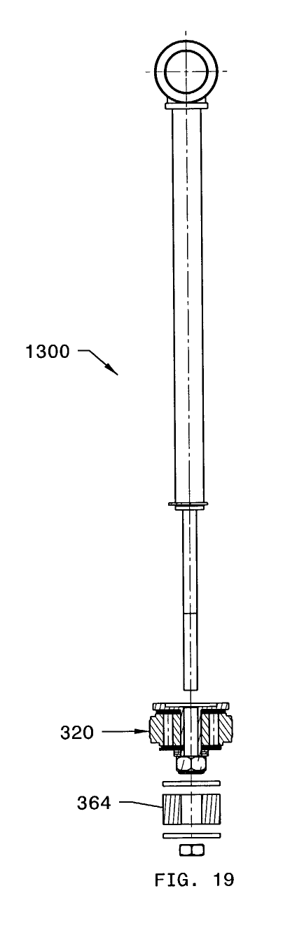

FIG. 19 illustrates a shock rod assembly 1300. The shock rod assembly is a variation of the shock rod assembly for the shock absorber 1100 shown in FIG. 15. Here, the compression spring 164 has been replaced by a rubber spring 364, which is disposed adjacent to the piston assembly 320 on the side furthest from the top of the shock rod 110.

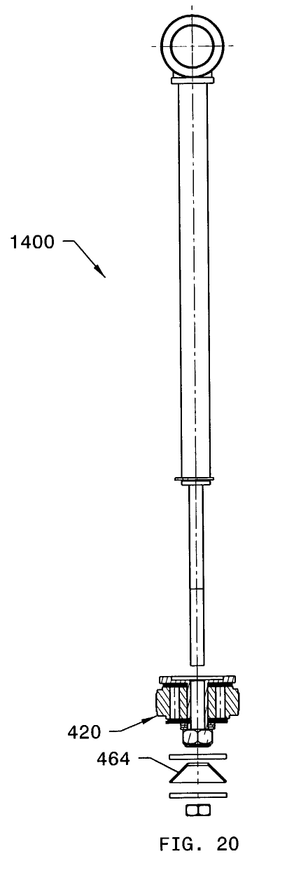

FIG. 20 illustrates a shock rod assembly 1400. The shock rod assembly 1400 is another variation of the shock rod assembly for the shock absorber 1100 shown in FIGS. 15 and 16. In this embodiment, the compression spring 164 has been replaced by a single cup spring 464, which is disposed adjacent to the piston assembly on the side furthest from the top of the shock rod 110.

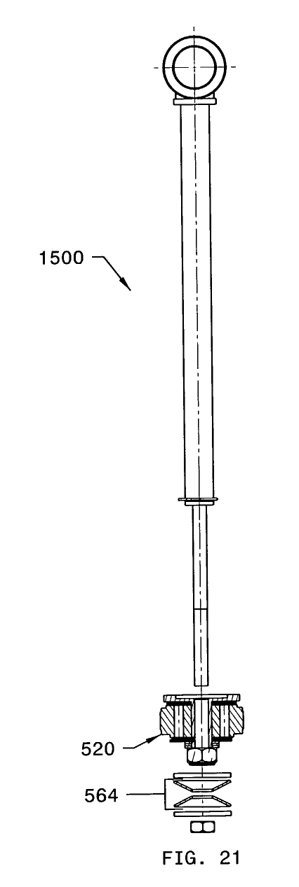

FIG. 21 illustrates the construction of a shock rod assembly 1500. This, too, is a variation of the shock rod assembly for the shock absorber 1100 illustrated in FIG. 15. Here, two cup springs 564 have been inserted in the place of the compression spring 164. The cup springs 564 are positioned on the side the piston assembly 520 furthest from the top of the shock rod 110.

As would be appreciated by those skilled in the art, shock absorbers 100 and 1200 (or their variations) will function in the same manner as shock absorbers 100 and 200 described above during the rebound stage and function as a conventional shock absorber in the compression stage. The operation of these shock absorbers 1100, 1200, generally, is not altered by the removal of one of the compression springs 160, 164, 260, 264. It is believed that the operation will not be exactly the same as that for the shock absorbers 100, 200 because of the removal of one of the compression springs 160, 164, 260, 264. However, as described above, these embodiments offer a more simplified construction that is lighter in weight than the shock absorbers 100, 200. Therefore, they offer other advantages to the overall performance of the vehicle on which they are installed.

The shock absorber of the present invention is preferably made from steel or aluminum and has a circular in cross sectional shape. However, as would be known by one skilled in the art, the shock absorber could be made in any shape and from any suitable material(s) capable of withstanding shocks experienced in the environment in which the shock absorber is designed to operate.

In addition, the springs are preferably made from steel, rubber, or plastic. However, as would be appreciated by those skilled in the art, other suitable materials also may be used without departing from the scope of the present invention.

While the invention has been described with reference to several preferred embodiments, it will be understood by those skilled in the art that various changes may be made and equivalents may be substituted for elements thereof without departing from the spirit and scope of the present invention. In addition, many modifications may be made to adapt a particular situation, component, or material to the teachings of the present invention without departing from its teachings as claimed.

What is claimed:

1. A shock absorber, comprising:
a shock rod having a longitudinal axis;
a shock body disposed around a portion of the shock rod, the shock body defining a fluid chamber therein and being slidable along the shock rod longitudinal axis; and
a piston disposed on the shock rod in sealing engagement with the shock body, the piston having at least one channel therethrough in communication with the fluid chamber,
wherein the piston is moveable longitudinally in relation to the shock rod within a predetermined range.

2. The shock absorber of claim 1, wherein the piston includes at least one valve in fluid communication with the at least one channel to control fluid movement therethrough.

3. The shock absorber of claim 1, wherein the piston defines a conduit therethrough, the shock rod extends though the conduit, and the piston is slideably moveable on the shock rod in a longitudinal direction.

4. The shock absorber of claim 1, further comprising:
a first spring support surface disposed on the shock rod; and
a compressible spring disposed in between the first spring support surface and the piston.

5. The shock absorber of claim 4, wherein the first compressible spring comprises at least one metallic coil spring.

6. The shock absorber of claim 4, wherein the first compressible spring comprises at least one cup spring.

7. The shock absorber of claim 4, wherein the first compressible spring comprises at least one rubber spring.

8. The shock absorber of claim 4, wherein the first compressible spring comprises a plastic material.

9. The shock absorber of claim 4, further comprising:
a second spring support surface disposed on the shock rod; and
a second compressible spring disposed in between the second spring support surface and the piston,
wherein the piston is moveable within a predetermined range between the first and second spring support surfaces and the first and second compressible springs are disposed adjacent to opposite sides of the piston.

10. The shock absorber of claim 9, wherein the second compressible spring comprises at least one metallic coil spring.

11. The shock absorber of claim 9, wherein the second compressible spring comprises at least one cup spring.

12. The shock absorber of claim 9, wherein the second compressible spring comprises at least one rubber spring.

13. The shock absorber of claim 9, wherein the second compressible spring comprises a plastic material.

14. The shock absorber of claim 1, wherein the shock rod further comprises a first end disposed within the shock body and a second end disposed outside of the shock body; and
the shock absorber further comprises a guide disposed on the shock rod between the piston and the shock rod first end, the guide being in slidable engagement with the shock body.

15. The shock absorber of claim 14, wherein the guide includes a guide surface in slidable engagement with the shock body.

16. The shock absorber of claim 9, wherein the shock rod further comprises a first end disposed within the shock body and a second end disposed outside of the shock body; and
the shock absorber further comprises a guide disposed on the shock rod between the piston and the shock rod first end.

17. The shock absorber of claim 1, further comprising:
a piston support, the piston support being disposed between the piston and the shock rod.

18. The shock absorber of claim 17, wherein the piston support includes a body having a first end, a second end, and a conduit which extends through the piston support between the first and second ends; and
the shock rod passes through the conduit.

19. The shock absorber of claim 18, wherein the piston support comprises a hollow cylindrical body having a first end comprising an outwardly extending ring-shaped flange, a second threaded end, and a conduit which extends therethrough between the first and second ends; and
the shock rod passes through the hollow cylindrical body conduit.

20. The shock absorber of claim 19, wherein:
the piston and at least one valve are positioned onto the piston support between the first ring shaped end and the second threaded end of the piston support; and
the piston, the at least one valve and the piston support together create a piston assembly which is moveable longitudinally along the shock rod within a predetermined range.

21. The shock absorber of claim 1, wherein the piston comprises a piston assembly, the piston assembly comprising:
a piston support including a body having a conduit extending therethrough, a first end and a second end, the shock rod extending through the piston support conduit between the first and second ends, and
a piston body disposed on the piston support between the first and second ends, the piston body including at least one channel therethrough.

22. The shock absorber of claim 21, wherein the piston support first end includes an outwardly extending flange, and the piston support second end is adapted to receive a fastener.

23. The shock absorber of claim 21, further comprising:
a spring support surface disposed on the shock rod; and
a compressible spring disposed in between the spring support surface and the piston.

24. The shock absorber of claim 21, further comprising:
a first spring support surface disposed on the shock rod;
a first compressible spring disposed between the first spring support surface and the piston assembly first end;
a second spring support surface disposed on the shock rod; and
a second compressible spring disposed between the second spring support surface and the piston assembly second end.

25. The shock absorber of claim 24, wherein the piston support first end includes an outwardly extending ring-shaped flange.

26. The shock absorber of claim 24, further comprising at least one valve disposed between the piston body and the outwardly extending flange.
